(19) United States
(12) Patent Application Publication
(10) Pub. No.: US 2025/0179866 A1
(43) Pub. Date: Jun. 5, 2025

(54) GLAZING

(71) Applicant: Bauglasindustrie GmbH, Schmelz/Saar (DE)

(72) Inventors: Salvatore TABONE, Saarlouis (DE); Herbert SCHÖBEN, Nohfelden (DE); Wolfgang DUTT, Wallerfangen (DE)

(21) Appl. No.: 18/842,825

(22) PCT Filed: Mar. 1, 2023
(86) PCT No.: PCT/EP2023/055176

§ 371 Date: Aug. 30, 2024

(30) Foreign Application Priority Data
Mar. 1, 2022 (GB) 2202834.4

(51) Int. Cl. E06B 3/66

(52) U.S. Cl. CPC E06B 3/6604; E06B 3/6621

(57) ABSTRACT

Glazings including first and second channel-section glazing elements are described. The first and second channel-section glazing elements are arranged to define a cavity in which an inner glazing element made of plastic is located. The inner glazing element includes a central portion and first and second edge portions running along opposite sides of the central portion. The first edge portion of the inner glazing element includes a first connection portion in mechanical communication with a first flange of the first channel-section glazing element. The first connection portion is integrally formed with the central portion of the inner glazing element. In preferred embodiments the second edge portion of the inner glazing also includes a second connection portion that is preferably integrally formed with the central portion of the inner glazing element.

The present invention relates to a glazing having first and second channel-section glazing elements with an inner glazing element made of plastic therebetween.

Glazing units comprising three spaced apart panes of glazing material are known in the art, such glazing units often being referred to as triple glazed windows. In such triple glazed windows each of the glazing elements, or panes, are usually planar sheets of glass.

Glazing elements are known having a profiled or channel-section configuration. A profiled or channel-section glazing element is made from a sheet or ribbon of glass and has at least one lateral edge bent upwards during manufacture. Usually both lateral edges are bent upwards during manufacture. Examples of making a channel-section glazing element are described in DE1496047A1. The upward facing portions of the channel-section glazing element are known in the art as “flanges” and the lower portion connected to the or each flange is known as a “web”. Since channel-section glazing elements are made from a continuous glass sheet or ribbon and cut to the desired length, the flanges are a continuation of the web and are at an angle thereto. Usually the flanges are at an angle of substantially 90° to the web. A channel-section glazing element having two lateral flanges is often referred to as a U-profile glazing element because the channel-section glazing element has a U-shaped cross section.

EP 0 742 324 A1 describes a facade consisting of two rows of U-shaped glass sections, one row forming the inner skin with its bases and the other similarly forming the outer skin, such that the legs of the U's fit one inside the other. Cavities are filled with thermal insulation and a heat reflecting layer is provided on one of the outwards facing surfaces of the skins and/or the thermal insulation. The U-sections may be positioned so that they abut each other and the legs of the U-sections are joined with PVC scaling strips and/or silicone sealing members. Such glazing units have limited visible transparency due to the nature of the thermal insulation. Furthermore the facades having three U-sections described in EP 0742 324 A1 are relatively thick (the thickness of such a facade being the distance between the surface facing the exterior of a building in which the facade is installed and the surface facing the interior of the building in which the facade is installed).

WO2005/033432A1 describes a translucent glazing panel comprising: (a) a thermoplastic panel comprising (i) an outer wall having an inner surface defining an internal channel, the internal channel having an internal volume, and (ii) at least one inner wall protruding from the inner surface into the internal channel, and (b) hydrophobic aerogel particles, the hydrophobic aerogel particles being disposed within the channel. Such glazing panels are translucent and are not able to be used in applications requiring low haze.

Glazings including glass sheets between channel-section glazing elements are described in WO2015/007899A2. The glass sheets are held in position using clips.

Glazings including at least one row of profiled glass sheets arranged next to one another, each with at least one web and at least one flange, and at least one multiple web plate made of plastic, are described in EP3260621B1. The multiple web plates made of plastic are attached to a separate holding device and are not attached to the profiled glass sheets.

Glazings including channel-section glazing elements are also described in CN113565239A, CN209114716U, CN2692238Y and DE102015100962B3.

There is a need for an improved glazing unit that can be used in glazing applications where increased energy performance is required. The ability to retrofit such glazing units into existing glazing systems is desirable. The ability to be able to simplify the production and installation of such glazing units is also desirable.

Accordingly, the present invention provides a glazing comprising a first channel-section glazing element and a second channel-section glazing element, the first and second channel-section glazing elements each comprising a web and a first flange, the first flange running along a first lateral edge of the respective web, the first and second channel-section glazing elements being arranged such that the first flange of the first channel-section glazing element faces the second channel-section glazing element and the first flange of the second channel-section glazing element faces the first channel-section glazing element, wherein an inner glazing element made of plastic is located between the first and second channel-section glazing elements, the inner glazing element comprising a central portion, a first edge portion running along a first side of the central portion and a second edge portion running along a second side of the central portion, the first side of the central portion being opposite the second side of the central portion, wherein the first edge portion of the inner glazing element is adjacent the first flange of the first channel-section glazing element, characterised in that the first edge portion of the inner glazing element comprises a first connection portion in mechanical communication with the first flange of first channel-section glazing element, the first connection portion being integrally formed with the central portion.

A glazing according to the present invention has an improved energy performance when compared to the same glazing without the inner glazing element. The inner glazing element helps improve the thermal insulation properties of the glazing.

The central portion may be suitably sized to substantially or completely fill the space between the web of the first channel-section glazing element and the web of the second channel-section glazing element.

Preferably the glazing is arranged such that there is a first space between the central portion of the inner glazing element and the web of the first channel-section glazing element and a second space between the central portion of the inner glazing element and the web of the second channel-section glazing element.

Preferably the first connection portion of the inner glazing element is attached to the first flange of first channel-section glazing element.

Preferably the first flange of first channel-section glazing element has a first gasket on at least a portion thereof, and the first connection portion of the inner glazing element is attached to the first flange of first channel-section glazing element using the first gasket.

Preferably the central portion of the inner glazing element comprises at least a first wall spaced apart from a second wall, the first and second walls of the central portion of the inner glazing element having at least one space therebetween.

Preferably the central portion of the inner glazing element has a multi-wall construction comprising a first wall facing the web of the first channel-section glazing element and a second wall facing the web of the second channel-section glazing element, there being a plurality of air-spaces between the first and second walls of the cen208tral portion of the inner glazing element.

Such multi-wall construction plastic sheets are well known in the art, see for example DE2722817A1, EP0050462A1, DE202011003120U1, DE202011109408U1 and DE202011106659U1.

Preferably the first connection portion has a multi-wall construction comprising at least a first and a second wall with at least one air space therebetween.

Preferably the first connection portion comprises a first element biased against the first flange of the first channel-section element.

Preferably the first connection portion is adhesively attached to the first flange of the first channel-section glazing element.

Preferably the web of the first channel-section glazing element has a second flange running along a second lateral edge thereof, the second lateral edge of the web of the first channel-section glazing element being opposite the first lateral edge of the web of the first channel-section glazing element, more preferably wherein the first channel-section glazing element has a U-shaped profile.

Preferably the web of the second channel-section glazing element has a second flange running along a second lateral edge thereof, the second lateral edge of the web of the second channel-section glazing element being opposite the first lateral edge of the web of the second channel-section glazing element, more preferably wherein the second channel-section glazing element has a U-shaped profile.

In embodiments where the web of the first channel-section glazing element has a second flange running along a second lateral edge thereof, the second lateral edge of the web of the first channel-section glazing element being opposite the first lateral edge of the web of the first channel-section glazing element, preferably the first flange of the second channel-section glazing element is received in the space between the first and second flanges of the first channel-section glazing element.

In some embodiments, the first flange of the first and second channel-section glazing elements each has a respective first end opposite the respective web thereof, the glazing being arranged such that the first end of the first flange of the first channel-section glazing element faces the first end of the first flange of the second channel-section glazing element.

In some embodiments, the first flange of the first and second channel-section glazing elements each has a respective first end opposite the respective web thereof, the glazing being arranged such that the first end of the first flange of the first channel-section glazing element faces the first end of the first flange of the second channel-section glazing element, and the web of the first channel-section glazing element has a second flange running along a second lateral edge thereof, the second lateral edge of the web of the first channel-section glazing element being opposite the first lateral edge of the web of the first channel-section glazing element; and the web of the second channel-section glazing element has a second flange running along a second lateral edge thereof, the second lateral edge of the web of the second channel-section glazing element being opposite the first lateral edge of the web of the second channel-section glazing element: an end of the first flange of the first channel-section glazing element faces an end of the first flange of the second channel-section glazing element and an end of the second flange of the first channel-section glazing element faces an end of the second flange of the second channel-section glazing element.

In some embodiments, the second edge portion of the inner glazing element comprises a second connection portion.

Preferably the second connection portion is suitable for attaching to a flange of a channel section-glazing element.

Preferably the second connection potion is integrally formed with the central portion.

Preferably the second connection portion of the inner glazing element is in mechanical communication with the first flange of the second-channel section glazing element, or when present, the second flange of the second channel-section glazing element.

Preferably the second connection portion of the inner glazing element is attached to the first flange of the second channel-section glazing element, or when present, the second flange of the second channel-section glazing element.

Preferably the first flange of second channel-section glazing element has a first gasket on at least a portion thereof, and the second connection portion of the inner glazing element is attached to the first flange of second channel-section glazing element using the first gasket, or when present, the second flange of second channel-section glazing element has a first gasket on at least a portion thereof, and the second connection portion of the inner glazing element is attached to the second flange of second channel-section glazing element using the first gasket.

Preferably the second connection portion comprises a first element biased against the first flange of the second channel channel-section element, or when present, the second flange of the second channel-section glazing element.

Preferably the second connection portion is adhesively attached to the first flange of the second channel-section glazing element, or when present, the second flange of the second channel-section glazing element.

Preferably the second connection portion has a multi-wall construction comprising at least a first and a second wall with at least one air space therebetween.

In some embodiments the first connection portion has a multi-wall construction comprising at least a first and a second wall with at least one air space therebetween.

In some embodiments the first connection portion of the inner glazing element is in mechanical communication with the first flanges of the first and second channel-section glazing elements, preferably wherein the first connection portion of the inner glazing element is attached to the first flanges of the first and second channel section glazing elements.

In some embodiments the web of the first channel-section glazing element has a second flange running along a second lateral edge thereof, the second lateral edge of the web of the first channel-section glazing element being opposite the first lateral edge of the web of the first channel-section glazing element, preferably wherein the first channel-section glazing element has a U-shaped profile; and the web of the second channel-section glazing element has a second flange running along a second lateral edge thereof, the second lateral edge of the web of the second channel-section glazing element being opposite the first lateral edge of the web of the second channel-section glazing element, preferably wherein the second channel-section glazing element has a U-shaped profile; and an end of the first flange of the first channel-section glazing element faces an end of the first flange of the second channel-section glazing element and an end of the second flange of the first channel-section glazing element faces an end of the second flange of the second channel-section glazing element.

Preferably the first connection portion of the inner glazing element is in mechanical communication with the first flanges of the first and second channel section glazing elements, preferably wherein the first connection portion of the inner glazing element is attached to the first flanges of the first and second channel section glazing elements.

Preferably the second edge portion of the inner glazing element comprises a second connection portion and wherein the second connection portion of the inner glazing element is in mechanical communication with the second flanges of the first and second channel-section glazing elements, preferably wherein the second connection portion of the inner glazing element is attached to the second flanges of the first and second channel section glazing elements.

In some embodiments the glazing further comprises a third channel-section glazing element comprising a web and a first flange running along a first lateral edge thereof, the glazing being arranged such that the first flange of the first channel-section glazing element faces the web of the third channel-section glazing element: the first flange of the second and third channel-section glazing elements faces the web of the first channel-section glazing element, and wherein the first flange of the third channel-section glazing element is between the first flange of the first channel-section glazing element and the first flange of the second channel-section glazing element.

Preferably the web of the first channel-section glazing element has a second flange running along a second lateral edge thereof, the second lateral edge of the web of the first channel-section glazing element being opposite the first lateral edge of the web of the first channel-section glazing element, more preferably wherein the first channel-section glazing element has a U-shaped profile; and wherein the web of the second channel-section glazing element has a second flange running along a second lateral edge thereof, the second lateral edge of the web of the second channel-section glazing element being opposite the first lateral edge of the web of the second channel-section glazing element, more preferably wherein the second channel-section glazing element has a U-shaped profile: wherein the second flange of the first channel-section glazing element faces the web of the second channel-section glazing element.

Preferably the first connection portion is in mechanical communication with the first flange of the second channel-section glazing element and/or the first flange of the third channel-section glazing element, preferably wherein the first connection portion is in attached to the first flange of the second channel-section glazing element and/or the first flange of the third channel-section glazing element. Preferably the glazing further comprises a fourth channel-section glazing element comprising a web and a first flange running along a first lateral edge thereof, the glazing being arranged such that the first flange of the fourth channel-section glazing element faces the web of the second channel-section glazing element; and wherein the first flange of the fourth channel-section glazing element is between the second flange of the first channel-section glazing element and the second flange of the second channel-section glazing element.

Preferably the second edge portion of the inner glazing element comprises a second connection portion and wherein the second connection portion of the inner glazing element is in mechanical communication with the second flanges of the first and second channel-section glazing elements, preferably wherein the second connection portion of the inner glazing element is attached to the second flanges of the first and second channel section glazing elements.

Preferably the second connection portion is in mechanical communication with the first flange of the fourth channel-section glazing element, preferably wherein the second connection portion is attached to the first flange of the fourth channel-section glazing element.

Other embodiments have other preferably features.

Preferably the first and/or second channel-section glazing elements comprise glass, more preferably a glass having a soda-lime-silica glass composition.

A typical soda-lime-silica glass composition is (by weight), SiO₂ 69-74%; Al₂O: 0-3%; Na₂O 10-16%: K₂O 0-5%; MgO 0-6%: CaO 5-14%: SO₃ 0-2%: Fc₂O₃ 0.005-2%. The glass may also contain other additives, for example, refining aids, which would normally be present in an amount of up to 2%.

Preferably the inner glazing element is extruded plastic.

Preferably the inner glazing element is made from polycarbonate, acrylic or polyester.

Preferably the first connection portion has a thickness between 0.5 mm and 50 mm, more preferably between 0.5 mm and 40 mm, or 30 mm, or 20 mm, or 10 mm.

When present, preferably the second connection portion has a thickness between 0.5 mm and 50 mm, more preferably between 0.5 mm and 40 mm, or 30 mm, or 20 mm, or 10 mm.

Other embodiments have other preferable features.

Preferably the web of the first channel-section glazing element has a second flange running along a second lateral edge thereof, the second lateral edge of the web of the first channel-section glazing element being opposite the first lateral edge of the web of the first channel-section glazing element. Preferably the first and second flanges of the first channel-section glazing element both project in the same direction away from the web.

Preferably the web of the second channel-section glazing element has a second flange running along a second lateral edge thereof, the second lateral edge of the web of the second channel-section glazing element being opposite the first lateral edge of the web of the second channel-section glazing element. Preferably the first and second flanges of the second channel-section glazing element both project in the same direction away from the web.

The web of the first channel-section glazing element has a first major surface and a second opposing major surface. Preferably at least a portion of the first and/or second major surface of the web of the first channel-section glazing element has a coating thereon. Preferably the coating is a low emissivity coating. Preferably the coating is a solar control coating.

The web of the second channel-section glazing element has a first major surface and a second opposing major surface. Preferably at least a portion of the first and/or second major surface of the web of the second channel-section glazing element has a coating thereon. Preferably the coating is a low emissivity coating. Preferably the coating is a solar control coating.

In a preferred embodiment the glazing the first and second channel-section glazing elements each comprise a web, a first flange and a second flange, the first flange running along a first lateral edge of the respective web and the second flange running along a second lateral edge of the respective web, the first lateral edge of the web being opposite the second lateral edge of the web, the first and second channel-section glazing elements being arranged such that the first flange of the first channel-section glazing element faces the first flange of the second channel-section glazing element and the second flange of the first channel-section glazing element faces the second flange of the second channel-section glazing element. In this arrangement preferably the first flange of the first channel-section glazing element is coplanar with the first flange of the second channel-section glazing element and the second flange of the first channel-section glazing element is coplanar with the second flange of the second channel-section glazing element.

Preferably the inner glazing element extends between the first and second flanges of the first channel-section glazing element.

Preferably the inner glazing element extends between the first and second flanges of the second channel-section glazing element.

Preferably the first and second channel-section glazing elements are separated by a gap and the inner glazing element is positioned in the gap.

In embodiments where the first channel-section glazing element has first and second flanges, preferably the first flange of the second channel-section glazing element is received in the space between the first and second flanges of the first channel-section glazing element.

In some embodiments the web of the first and/or second channel-section glazing element is curved or corrugated, for example as in the channel-section glazing elements described in WO2008068324A1.

In one embodiment, the first channel-section glazing element is made of annealed glass and not thermally toughened glass, the second channel section glazing element is made of annealed glass and not thermally toughened glass and the glass glazing element is made of toughened glass and not annealed glass.

In another embodiment, the first channel-section glazing element is made of annealed glass and not thermally toughened glass, the second channel section glazing element is made of annealed glass and not thermally toughened glass and the sheet of glass glazing is made of annealed glass and not thermally toughened glass.

Glazings in accordance with the first aspect of the present invention have other preferable features.

Preferably the inner glazing element is monolithic.

Preferably the first and/or second channel-section glazing element is optically transparent.

Preferably the first and/or second channel-section glazing element is laminated.

Preferably the first and/or second channel-section glazing element is coated over at least a portion thereof to provide the respective channel-section glazing element with a region having a different colour in reflected or transmitted light compared to the uncoated channel-section glazing element. Such a coating may be optically opaque. Suitably the coating is a paint.

Preferably the web of the first and/or second channel-section glazing element has a thickness between 4 mm and 12 mm, more preferably between 5 mm and 8 mm.

Preferably the or each flange of the first and/or second channel-section glazing element has a thickness of between 4 mm and 12 mm, more preferably between 5 mm and 8 mm.

Preferably the thickness of the web of the first channel-section glazing element is the same as the thickness of the or each flange of the first channel-section glazing element.

Preferably the thickness of the web of the second channel-section glazing element is the same as the thickness of the or each flange of the first channel-section glazing element.

Suitable coatings that may be useful with glazings according to the present invention include low-emissivity coatings, conductive coatings, and solar control coatings. A low emissivity coating is a coating which when applied to clear, 3 mm thick float glass, results in the coated glass having an emissivity in the range of 0.05 to 0.45, the actual value being measured in accordance with EN 12898 (a published standard of the European Association of Flat Glass Manufacturers). Suitably a low emissivity coating comprises at least one layer comprising tin oxide.

Typical solar control coatings comprise layers of silver or tin oxide and control the amount of heat absorbed through the coated glass. Solar control and low emissivity coatings may also be electrically conductive, and so not only provide functionality to the glass in terms of emissivity and heat transmission but can form an electrically conductive substrate for mounting electrically conductive devices.

Such coatings may be applied using techniques known in the art, for example atmospheric pressure chemical vapour deposition or spray pyrolysis.

When the first and/or second channel-section glazing element has two flanges, preferably the thickness of each flange is the same.

In embodiments where the inner glazing element has a central portion having a multi-wall construction, preferably at least one of the walls of the central portion has a thickness less than about 5 mm and/or a thickness greater than 0.05 mm. The thickness of at least one of the walls of the central portion may be between 0.5 mm and 3 mm.

In embodiments where the inner glazing element has a first connection portion having a multi-wall construction, preferably at least one of the walls of the first connection portion has a thickness less than about 5 mm and/or a thickness greater than 0.05 mm. The thickness of at least one of the first connection portion may be between 0.5 mm and 3 mm.

In embodiments where the inner glazing element has a second connection portion having a multi-wall construction, preferably at least one of the walls of the second connection portion has a thickness less than about 5 mm and/or a thickness greater than 0.05 mm. The thickness of at least one of the first connection portion may be between 0.5 mm and 3 mm.

In embodiments where the inner glazing element has a central portion having a multi-wall construction, preferably the central portion has a thickness between 5 mm and 500 mm, or 400 mm, or 300 mm, or 200 mm, or 100 mm. The central portion may have less than 50 walls extending along a first axis, the first axis preferably being parallel to the web of the first and/or second channel-section glazing element. The central portion preferably has a plurality of walls extending along a second axis, the second axis preferably being perpendicular to the web of the first and/or second channel-section glazing element.

In embodiments where the inner glazing element has a first connection portion having a multi-wall construction, preferably the first connection portion has a thickness between 1 mm and 200 mm. The first connection portion preferably has a plurality of walls extending along a first axis, the second axis preferably being perpendicular to the web of the first and/or second channel-section glazing element. The first connection portion preferably has a plurality of walls extending along a second axis, the second axis preferably being perpendicular to the web of the first and/or second channel-section glazing element.

In embodiments where the inner glazing element has a second connection portion having a multi-wall construction, preferably the first connection portion has a thickness between 1 mm and 200 mm. The second connection portion preferably has a plurality of walls extending along a first axis, the second axis preferably being perpendicular to the web of the first and/or second channel-section glazing element. The second connection portion preferably has a plurality of walls extending along a second axis, the second axis preferably being perpendicular to the web of the first and/or second channel-section glazing element.

In embodiments where the glazing is arranged such that there is a first space between the central portion of the inner glazing element and the web of the first channel-section glazing element and a second space between the central portion of the inner glazing element and the web of the second channel-section glazing element, the webs of the first and second channel-section glazing elements are spaced apart by a spacing and the central portion has a thickness less than the spacing between the webs of the first and second channel-section glazing elements.

Preferably the central portion has a thickness that is less than 90% of the spacing between the webs of the first and second channel-section elements, more preferably less than 80%, or 70% or 60%, or 50%, or 40%, or 30%, or 20%, or 10%, or 5% of the spacing between the webs of the first and second channel-section elements.

Preferably the central portion has a thickness that is at least 2% or 3% or 4% of the spacing between the webs of the first and second channel-section elements.

Preferably the central portion has a thickness between 0.5 cm and 50 cm, more preferably between 0.5 cm and 40 cm, or 30 cm, or 20 cm, or 10 cm, or 5 cm.

Glazings in accordance with the present invention may be retrofit into existing facades comprising a plurality of channel-section glazing elements.

The invention will now be described with reference to the following figures (not to scale) in which,

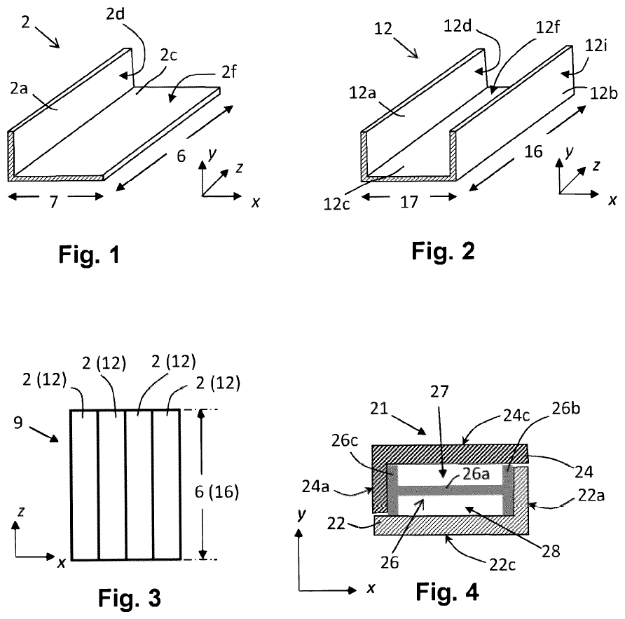

FIG. 1 is an isometric projection of a channel-section glazing element having only one flange continuous with a web;

FIG. 2 is an isometric projection of a channel-section glazing element having a web and two flanges continuous with the web:

FIG. 3 is a front view of a part of a facade for a building comprising four channel-section glazing elements:

FIG. 4 is a cross-sectional view of a glazing according to the present invention:

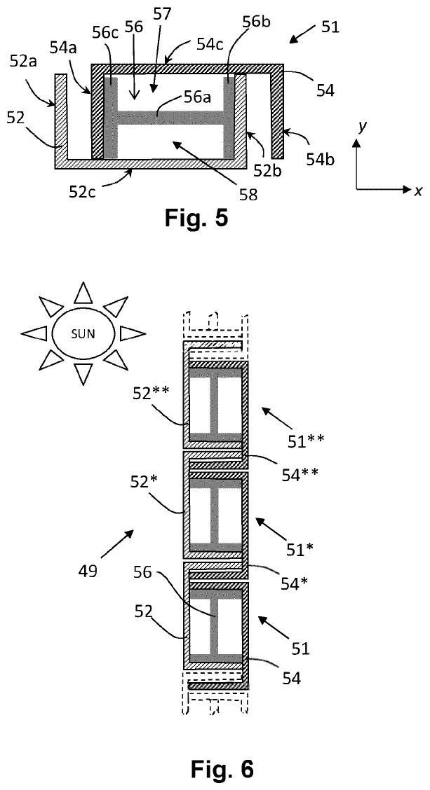

FIG. 5 is a cross-sectional view of another glazing according to the present invention:

FIG. 6 is a cross-sectional view of a facade comprising three glazings of the type shown in FIG. 5:

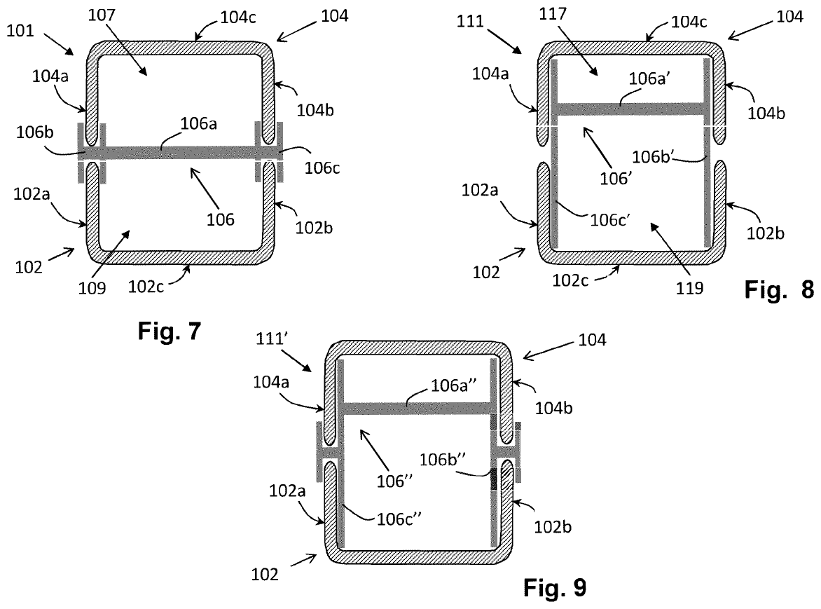

FIG. 7 is a cross-sectional view of another glazing according to the present invention:

FIG. 8 is a cross-sectional view of another glazing according to the present invention:

FIG. 9 is a cross-sectional view of another glazing according to the present invention:

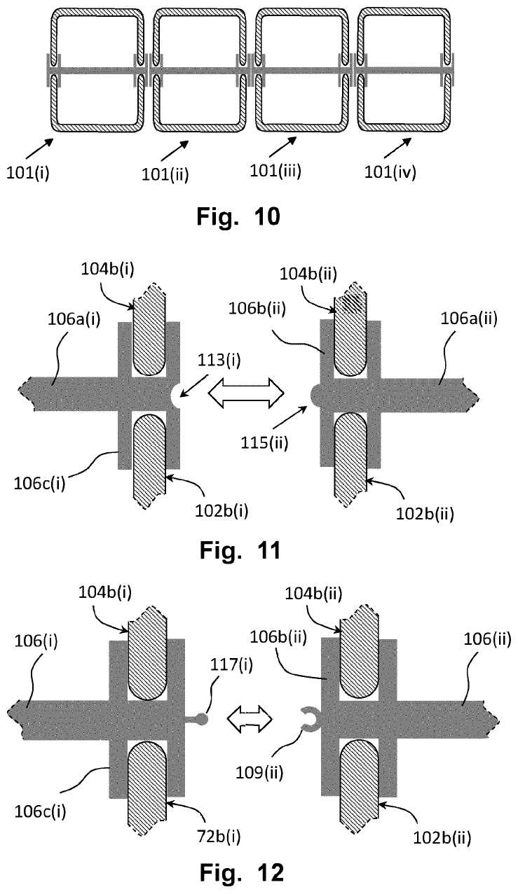

FIG. 10 is a cross-sectional view of a facade comprising four glazings of the type shown in FIG. 7:

FIG. 11 is a cross-sectional view of a portion of the facade shown in FIG. 10 illustrating how two adjacent connection portions of adjacent inner glazing elements engage:

FIG. 12 is a cross-sectional view of a portion of the facade shown in FIG. 10 illustrating another way how two adjacent connection portions of adjacent inner glazing elements engage:

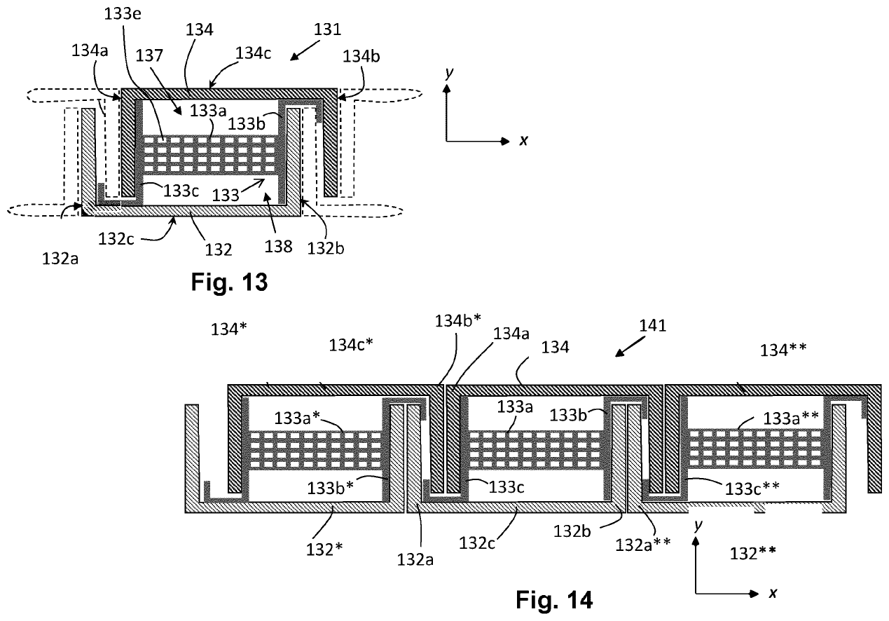

FIG. 13 is a cross-sectional view of another glazing according to the present invention:

FIG. 14 is a cross-sectional view of a facade comprising three glazings of the type shown in FIG. 13:

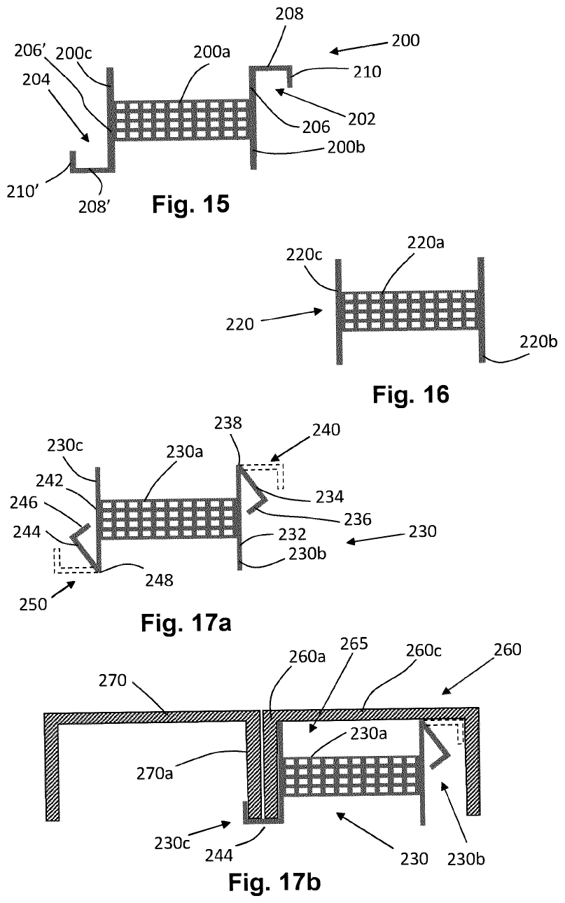

FIGS. 15-17a are cross-sectional views of inner glazing elements for use in the present invention:

FIG. 17b shows the inner glazing element of FIG. 17a in use; and

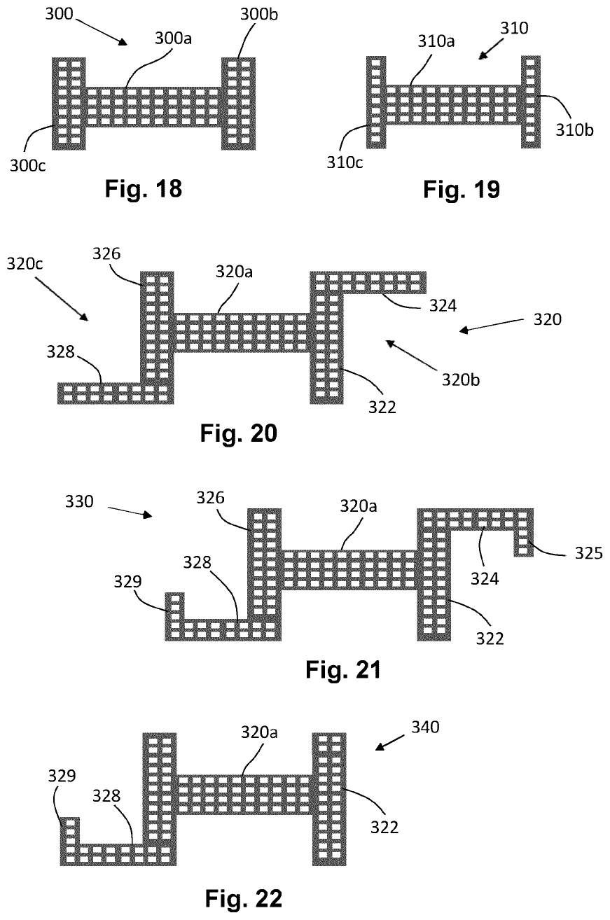

FIGS. 18-22 are cross-sectional views of other inner glazing elements for use in the present invention.

FIG. 1 shows a schematic perspective view of one type of channel-section glazing element 2 that may be used in making a glazing in accordance with the present invention. The channel-section glazing element 2 has a flange 2a and a web 2c integrally formed therewith. The flange 2a is continuous with the web 2c and the channel-section glazing element 2 has been bent from an initially flat sheet or ribbon of glass, for example as described in DE1496047A1. The width 7 of the web may be many cm, whereas the length 6 of the web may be many tens of cm, up to several meters.

The flange 2a has a first major surface 2d and an opposing second major surface 2e (not indicated in the figure). The web 2c has a first major surface 2f and an opposing second major surface 2g (not indicated in the figure).

The flange 2a is substantially perpendicular to the web 2c. In this example the web 2c has a thickness of 7 mm and the flange 2a also has a thickness of 7 mm.

With reference to the co-ordinate system shown, the web 2c is parallel to the plane x-z. The flange 2a is parallel to the plane y-z. When viewed along the z-axis, the channel-section glazing element 2 has an “L” cross-sectional profile.

FIG. 2 shows a schematic perspective view of another type of channel-section glazing element 12 that may be used in making a glazing in accordance with the present invention.

The channel-section glazing element 12 has a first flange 12a, a second flange 12b and a web 12c. The flanges 12a, 12b are continuous (so integrally formed) with the web 12c and the channel-section glazing element 12 has been bent from an initially flat sheet or ribbon of glass, for example as described in DE1496047A1. The width 17 of the web may be many centimetres, whereas the length 16 of the web may be many tens of centimetres, up to several metres, for example 3 m to 10 m.

The first flange 12a has a first major surface 12d and an opposing second major surface 12e (not indicated in the figure). The second flange 12b has a first major surface 12h (not indicated in the figure) and an opposing second major surface 12i. The web 12c has a first major surface 2f and an opposing second major surface 12g (not indicated in the figure). The surface 12d of the first flange 12a faces the surface 12h of the second flange 12b.

The flanges 12a, 12b are each substantially perpendicular to the web 12c. In this example the web 12c has a thickness of 7 mm and the flanges 12a, 12b each have a thickness of 7 mm.

With reference to the co-ordinate system shown, the web 12c is parallel to the plane x-z. The flanges 12a, 12b are parallel to the plane y-z. When viewed along the z-axis, the channel-section glazing element 12 has a “U” cross-sectional profile.

The description of the channel-section glazing elements 2, 12 may be used in relation to the channel-section glazing elements described hereinafter.

FIG. 3 shows a front view of part of a facade 9 for a building comprising four channel-section glazing elements of the type described with reference to FIG. 1 or FIG. 2. With reference to FIG. 1 and FIG. 2, the facade is viewed in the direction of the y-axis.

As is known in the art, each channel-section glazing element 2 or 12 is arranged vertically in a supporting frame or mounting frame (not shown). For each channel-section glazing element 2 or 12 in the facade there may be suitable sealant material in between adjacent longitudinal edges.

The facade 9 may alternatively comprise horizontally orientated channel-section glazing elements.

FIG. 4 shows a cross-sectional view of a glazing 21 in accordance with the present invention. With reference to FIG. 1, this is a view in the direction of the z-axis.

The glazing 21 has a first channel-section glazing element 22 of annealed glass. The first channel-section glazing element 22 has a flange 22a and a web 22c. The flange 22a is continuous with the web 22c and the first channel-section glazing element has been bent from an initially flat sheet or ribbon of glass, for example as described in DE1496047A1.

The flange 22a is substantially perpendicular to the web 22c. The web 2c has a thickness of 7 mm. The flange 22a has a thickness of 7 mm.

The glazing 21 also has a second channel-section glazing element 24 of annealed glass. The second channel-section glazing element 24 has a flange 24a and a web 24c. The flange 24a is continuous with the web 24c and the first channel-section glazing element has been bent from an initially flat sheet or ribbon of glass, for example as described in DE1496047A1.

The flange 24a is substantially perpendicular to the web 24c. The web 24c has a thickness of 7 mm. The flange 24a has a thickness of 7 mm.

The second channel-section glazing element 24 has substantially the same dimensions as the first channel-section glazing element 22.

Both channel-section glazing elements 22, 24 are made of soda-lime-silica glass.

The first and second channel-section glazing elements are arranged such that the flange 22a of the first channel-section glazing element faces 22 faces the second channel-section glazing element 24, and the flange 24a of the second channel-section glazing element 24 faces the first channel-section glazing element 22. In this arrangement the inner facing surfaces of the channel-section glazing elements 22, 24 define a cavity.

There may be a low emissivity coating on a surface of the web 22c and/or 24c facing into the cavity.

In accordance with the present invention an inner glazing element 26 made of plastic having a central portion 26a and two connection portions 26b, 26c integrally formed therewith is located in the cavity defined by the inner facing surfaces of the channel-section glazing elements 22, 24.

The first connection portion 26b is in contact with the flange 22a and the second connection portion 26c is in contact with the flange 24a.

The first connection portion 26b may be attached to the flange 22a, for example by a suitable gasket over the flange 22a, and/or using a suitable adhesive.

The second connection portion 26c may be attached to the flange 24a, for example by a suitable gasket over the flange 24a, and/or using a suitable adhesive.

The inner glazing element 26 has an “H” profile.

The inner glazing element 26 has a length the same as that of the channel-section glazing elements 22, 24. The width of the inner glazing element 26 is about the same as the distance between the inner surfaces of the flanges 22a, 24a. The width of the inner glazing element 26 may be such that the inner glazing element is a snug fit between the flanges 22a, 24a.

With respect to the orientation of the glazing 21 as shown in FIG. 4, there is an upper space 27 between the web 24c and the glass sheet 26 and a lower space 28 between the glass sheet 26 and the web 22c.

The inner glazing element 26 divides the cavity defined by the inner facing surfaces of the channel-section glazing elements 22, 24 into two airspaces. This improves noise insulation. The glazing 21 also has improved thermal insulation properties (compared to the same arrangement without the inner glazing element 26).

The upper airspace 27 is 16 mm (distance from glass sheet 26 to inner facing surface of flange 24c) and the lower airspace 28 is 16 mm (distance from glass sheet 26 to inner facing surface of flange 22c).

The central portion 26a has a thickness of about 6 mm. The first and second connection portions also have a thickness of about 6 mm.

FIG. 5 shows a cross-sectional view of another glazing 51 in accordance with the first aspect of the present invention. With reference to FIG. 2, this is a view in the direction of the z-axis.

The glazing 51 has a first channel-section glazing element 52 having a first flange 52a, a second flange 52b and a web 52c. The flanges 52a, 52b are continuous with the web 52c and the first channel-section glazing element has been bent from an initially flat sheet or ribbon of glass, for example as described in DE1496047A1.

The glazing 51 also has a second channel-section glazing element 54 having a first flange 54a, a second flange 54b and a web 54c. The first channel-section glazing element 52 has the same dimensions as the second channel-section glazing element 54. This is advantageous because both the first and second channel-section glazing elements can be made during the same production run.

The first and second channel-section glazing elements are arranged such that the flange 54a faces the web 52c, and the flange 54a is between the flanges 52a, 52b. The outer surface of the flange 54a is spaced from the inner surface of the flange 52a by a sufficient amount such that a flange of another glazing may be located therebetween (as will be described with reference to FIG. 6).

As a consequence of the first and second channel-section glazing elements having the same dimensions and because the flange 52a is spaced from the flange 54a, the flange 52b is spaced from the flange 54b. The space between the outer surface of flange 52b and the inner surface of flange 54b is sufficient that a flange of an adjacent glazing may be located therebetween.

The inner surfaces of the flanges 54a, 52b and portions of the inner surfaces of the webs 52c, 54c define a cavity in which is located an inner glazing element 56. The inner glazing element is located between the web 52c and web 54c. There is an upper space 57 between the web 54c and the inner glazing element 56. There is a lower space 58 between the inner glazing element 56 and the web 52c.

The inner glazing element 56 is located between the second flange 52b of the first channel-section glazing element 52 and the first flange 54a of the second channel-section glazing element 54. As a result, the inner glazing element 56 is adjacent the flange 54a and also adjacent the flange 52b. In relation to the orientation of the glazing shown in FIG. 9, the left hand edge of the inner glazing element 56 is adjacent to the flange 54a and the right hand edge of the inner glazing element 56 is adjacent the flange 52b.

The inner glazing element 56 is made of polycarbonate and has a central portion 56a, a first connection portion 56b along a first edge of the central portion 56a and a second connection portion 56c along an opposite edge of the central portion 56a. The first and second connection portions are integrally formed with the central portion 56a.

There may be a low emissivity coating or a solar control coating on the surface of the web 52c. 54c facing away from the inner glazing element 56.

The low emissivity coating may comprise tin oxide.

The central portion of the inner glazing element 56 has a first major surface facing web 54c and a second major surface facing web 52c.

The central portion 56a and/or either of the first and second connection portions 56b, 56c may have a multi-wall construction. Such a construction helps improve thermal insulation.

FIG. 6 shows a cross-sectional view of part of a facade 49 comprising a plurality of glazings 51. Each glazing 51 is positioned adjacent another glazing 51. To aid with the description of FIG. 10, three glazings 51, 51* and 51** are highlighted. Each glazing 51, 51* and 51* is the same as illustrated in FIG. 9, therefore each component part of glazing 51* and 51** will be referenced in the same way as for glazing 51 except with the addition of a “*” or “***” respectively after each component part. For example, glazing 51 has a first channel-section glazing element 52 having a first flange 52a. Glazing 51* therefore has a first channel-section glazing element 52* having a first flange 52a*, and so on. Likewise, glazing 51** has a first channel-section glazing element 52** having a first flange 52a**, and so on.

When installing the glazing to make facade 49, the second flange 54b* of glazing 51* fits into the space between the second flange 52a and the second flange 54a of glazing 51 such that the flange 52a faces the web 54c* of the second channel-section glazing element 54* of glazing 51*. Consequently, the flange 54b* of the second channel-section glazing element 54* of the glazing 51* faces the web 52c of the first channel-section glazing element 52 of the glazing 51.

As shown in FIG. 6, the second flange 54b** of glazing 51** fits into the space between the second flange 52a* and the second flange 54a* of glazing 51* such that the flange 52a* faces the web 54c** of the second channel-section glazing element 54** of glazing 51**. Consequently, the flange 54b** of the second channel-section glazing element 54** of the glazing 51** faces the web 52c* of the first channel-section glazing element 52* of the glazing 51*.

The glazings 51 forming the facade 49 may be vertically or horizontally orientated.

For each glazing 51 in the facade there may be suitable sealant material in between adjacent longitudinal edges.

As shown in FIG. 6, the webs 52c of each first channel-section glazing element 52 of each respective glazing 51 form the outer surface of the facade i.e. that surface facing the outside of the building in which the facade is installed. The inner facing surface is formed by the webs 54c of the second channel-section glazing element 54 of each respective glazing 51.

Due to the inclusion of the inner glazing unit in each glazing 51 (as described with reference to FIG. 5), the facade has improved thermal performance. The thermal performance can be improved further by the inclusion of a low emissivity coating on the inner glazing elements and/or the first and/or second channel-section glazing elements.

FIG. 7 shows a glazing 101 in accordance with the present invention. The glazing 101 comprises a first channel-section glazing element 102 and a second channel-section glazing element 104. Each channel section glazing element 102, 104 is of the type described with reference to FIG. 2.

The channel-section glazing element 102 has a web 102c with flanges 102a, 102b at lateral edges thereof.

The channel-section glazing element 104 has a web 104c with flanges 104a, 104b at lateral edges thereof.

The channel-section glazing elements 102, 104 have substantially the same dimensions.

An end of the flange 102a faces an end of the flange 104a and an end of the flange 102b faces an end of the flange 104b.

The inner facing surfaces of the channel-section glazing elements 102, 104 define a cavity. The cavity is split into two airspaces 107, 109 by an inner glazing element 106 located in the cavity. The inner glazing element is made of plastic and has a central portion 106a, a first connection portion 106b and a second connection portion 106c.

The central portion 106a is a multi-wall construction and the first and second portions 106b, 106c are integrally formed therewith.

The first connection portion 106b has an “H” profile and is configured such that the ends of the flanges 102a, 104a engage therewith. The flanges 102a, 104b may be a snug fit with the first connection portion 106b. The flanges 102a, 104a are attached to the first connection portion 106b.

The second connection portion 106c is configured in the same way as the first connection portion 106b and is configured to be attached to the flanges 102b, 104b.

Given that the two channel-section glazing elements 102, 104 are substantially the same, the central portion 106a is positioned equidistant between the webs 102c, 104c. As a consequence the two airspaces 107, 109 are the same volume. The central portion 106a may have a thickness between 5 mm and 50 mm.

With the first and second channel-section glazing elements arranged as shown in FIG. 7, it may be desirable to position the central portion 106a at other positions in the cavity. This is shown in FIG. 8 and FIG. 9.

FIG. 8 shows another glazing 111 in accordance with the present invention. The glazing 111 comprises the same channel-section glazing elements 102, 104 as described with reference to the glazing 101 of FIG. 7. An inner glazing element 106′ is used to position the central portion 106a′ at a different location in the cavity. The central portion 106a′ is arranged to be positioned between the flanges 104a, 104b because the central portion is not mid-way between the first and second connection portions 106b, 106c.

FIG. 9 shows a glazing 11l′ which is the same as glazing 111 except that an inner glazing element 106″ is positioned in the cavity. The inner glazing element 106″ has a central portion 106a″ and first and second connection portions 106b″, 106c″. The first and second connection portions 106b″, 106c″ are configured with an “H”-type profile such that the ends of the flanges 102a, 104a can engage with the second connection portion 106c″ and the ends of the flanges 102b, 104b can engage with the first connection portion 106b″. This attaches the flanges to the inner glazing element 106″.

The first connection portion 106b″ is configured with two slots into which the ends of flanges 102b, 104b may be received. The first connection portion 106c″ is configured with two slots into which the ends of flanges 102a, 104a may be received.

The first and second connection portions shown in FIGS. 7 and 9 may be modified such that male and female interlocking members are on adjacent connection portions. This is illustrated in FIGS. 10, 11 and 12.

In FIG. 10 there are shown four glazings of the type shown in FIG. 7. The glazings are each referred to as 101 (i), 101 (ii), 101 (iii) and 101 (iv). The component parts in each glazing is designated by a (i), (ii), (iii) or (iv). For example, the inner glazing element in glazing 101 (ii) is referred to as 106 (ii).

Glazing 101 (i) is connected to glazing 101 (ii) because the second connection portion 106c (i) of glazing 101 (i) and the first connection portion 106b (ii) of glazing 101 (ii) have been modified. In one embodiment shown in FIG. 11 second connection portion 106c (i) has a groove 113 (i) configured to engage with a projection 115 (ii) on the side of the first connection portion 106b (ii). The projection 115 (ii) may be a snap fit with the groove 113 (i) and releasably attachable thereto i.e. in the direction of the arrow.

In another embodiment shown in FIG. 12 the second connection portion 106c (i) has a projecting element 117 (i) configured to engage with a projecting groove 119 (ii) on the side of the first connection portion 106b (ii). The projecting element 117 (i) fits into the projecting groove 119 (ii) and is releasably attachable thereto i.e. in the direction of the arrow.

Other forms of male/female engaging parts may be used to attached adjacent glazing together.

The use of first and second connection portions having male/female engaging parts of the type shown in FIGS. 11 and 12 is advantageous because each glazing 101 may be pre-assembled and a facade more quickly assembled by clipping together adjacent glazings.

The ends of the flanges and/or the ends of the flat glass sheet may be a snug fit in the respective slot of the each first and second connection portion.

FIG. 13 shows a cross-sectional view of another glazing 131 in accordance with the present invention. With reference to FIG. 2, this is a view in the direction of the z-axis. The glazing 131 is similar to the glazing 51 of FIG. 5.

The glazing 131 has a first channel-section glazing element 132 having a first flange 132a, a second flange 132b and a web 132c. The flanges 132a, 132b are continuous with the web 32c and the first channel-section glazing element has been bent from an initially flat sheet or ribbon of glass, for example as described in DE1496047A1.

The glazing 131 also has a second channel-section glazing element 134 having a first flange 134a, a second flange 134b and a web 134c. The first channel-section glazing element 132 has the same dimensions as the second channel-section glazing element 134. This is advantageous because both the first and second channel-section glazing elements can be made during the same production run.

The first channel-section glazing element 132 and second channel-section glazing element 134 are each of the type as described in relation to FIG. 2.

The first and second channel-section glazing elements 132, 134 are arranged such that the flange 134a faces the web 132c, and the flange 134a is received in the space between the flanges 132a, 132b. The outer surface of the flange 134a is spaced from the inner surface of the flange 132a by a sufficient amount such that a flange of another glazing may be located therebetween.

As a consequence of the first and second channel-section glazing elements having the same dimensions and because the flange 132a is spaced from the flange 134a, the flange 132b is spaced from the flange 134b. The space between the outer surface of flange 132b and the inner surface of flange 134b is sufficient that a flange of an adjacent glazing may be located therebetween.

The inner surfaces of the flanges 134a, 132b and portions of the inner surfaces of the webs 132c, 134c define a cavity in which is located an inner glazing element 133. The inner glazing element 133 is made of suitable plastic such as polycarbonate or the like and has a central portion 133a and first and second connection portions 133b, 133c integrally formed with the central portion 133a. There is an upper space 137 between the web 134c and the central portion 133a. There is a lower space 138 between the central portion 133a and the web 132c.

There may be a low emissivity coating or a solar control coating on the surface of the web 132c, 134c facing the central portion 133a.

There may be a low emissivity coating or a solar control coating on the surface of the web 132c, 134c facing away from the central portion 133a.

The low emissivity coating may comprise tin oxide.

There may be a solar control coating on the web 132c and/or web 134c. There may be a solar control coating on the web 132c and/or web 134c. There may be a solar control coating on the web 132c and a solar control coating on the web 134c.

The first connection portion 133b is in contact with the flange 132b and extends over an upper end thereof. This spaces the upper end of the flange 132b from the web 134c.

The second connection portion 133c is in contact with the flange 134a and extends over a lower edge of the flange 134a. This spaces the lower end of the flange 134a from the web 1322.

In this example the central portion 133a has a multi-wall configuration comprising a plurality of walls extending horizontally and vertically to define a plurality of air-spaces 133e (only one of which is labelled). Other arrangement of walls is also possible, for example as a honeycomb.

In this example the first and second connection portions 133b, 133c have a single wall construction.

FIG. 14 shows a cross-sectional view of a facade 141 comprising a plurality of glazings 131of the type shown in FIG. 13. Each glazing 131 is positioned adjacent another glazing 131.

To aid with the description of FIG. 14, three glazings 131, 131* and 131** are highlighted. Each glazing 131, 131* and 131** is the same as illustrated in FIG. 13, therefore each component part of glazing 131* and 131** will be referenced in the same way as for glazing 131 except with the addition of a “*” or “***” respectively after each component part.

When installing the glazing to make facade 141, the second flange 134b* of glazing 131* fits into the space between the flange 132a and the flange 134a of glazing 131 such that the flange 132a faces the web 134c* of the second channel-section glazing element 134* of glazing 131*. Consequently, the flange 134b* of the second channel-section glazing element 134* of the glazing 131* faces the web 132c of the first channel-section glazing element 132 of the glazing 131.

The glazings 131 forming the facade 141 may be vertically or horizontally orientated.

For each glazing 131, 131*, 131** etc. in the facade there may be suitable sealant material in between adjacent longitudinal edges.

With reference to FIGS. 13 and 14, in the space between the first flange 134a of the channel-section glazing element 134 and the first flange 132a of the channel-section glazing element 132 is the second flange 134b* of the channel-section glazing element 134*.

The second connection portion 133c is located over the ends of the first flange 134a and the second flange 134b*. On one side the second connection portion 133c extends part way down the second flange 134b* towards the web 134c*. On the other side, the second connection portion 133c extends the whole length of the inside of the first flange 134a towards the web 134c. The second connection portion 133c is attached to the flanges 134a, 134b*.

The first connection portion 133a is configured in the same way and is shown attached to the flanges 132b, 132a**.

FIG. 15 shows a cross-sectional view of an inner glazing element 200 that is used in the glazing 131. The inner glazing element 200 is configured in the same way as the inner glazing element 133.

The inner glazing element 200 is made from plastic such as polycarbonate and may be optically transparent or translucent. The inner glazing element 200 has a central portion 200a having a multi-wall construction comprising a plurality of walls defining a plurality of air spaces. In this example there are five horizontal walls, nine vertical walls (including two walls being part of the first and second connection portions 200b, 200c) defining forty air spaces as shown, although there may be more or less walls and/or air spaces.

Integrally formed with the central portion 200a is a first connection portion 200b and a second connection portion 200c. In this example, each connection portion is a single wall construction having a thickness of less than 10 mm i.e. 2-6 mm.

The first connection portion 200b has a hook portion 202 into which at least one, preferably at least two, flange portions of channel-section glazing elements can fit, see for example FIGS. 13 and 14. The second connection portion 200c has a hook portion 204 into which at least one, preferably at least two, flange portions of channel-section glazing elements can fit, see for example FIGS. 13 and 14.

The first connection portion 200b has a first connection element 206, a second connection element 208 and a third connection element 210. The first connection element 206 is sheet-like and is perpendicular to the central portion 200a. The second connection element 208 is also sheet-like and is perpendicular to the first connection element 206. The third connection element 210 is also sheet-like and is perpendicular to the second element 208. Consequently, the third connection element 210 is parallel to the first connection element 206.

The second connection portion 200c is configured the same way, having first, second and third connection elements 206′, 208′ and 210′ but with the second connection element 208′ and third connection element 210′ extending in opposite directions, as shown in FIG. 15.

The inner glazing element 200 may be produced by extrusion through a suitably configured die.

In an alternative embodiment, the first and/or second connection portions 200b, 200c do not have a respective third connection element 210, 210′.

In another alternative embodiment, and with reference to FIGS. 13 to 15, the second connection element 208 may have at least a double walled construction such that one wall of the second connection element 208 is configured to face the upper ends of the flange 132b and the flange 132a** and the other wall of the second connection element 208 is configured to face the web 134, there being at least a first space between the walls of the second connection element 208. Such a double walled configuration provides the second connection element 208 with a thermal break between the upper ends of the flange 132b and the flange 132a** and the web 134. The second connection portion may have a second connection element configured in a similar manner.

FIG. 16 shows a cross-sectional view of an inner glazing element 220 that may be used in a glazing according to the present invention.

The inner glazing element 220 is made of plastic and may be made by extrusion using a suitable configured die.

The inner glazing element comprises a central portion 220a and first and second connection portions 220b, 220c integrally formed therewith.

The first and second connection portions 220b, 220c are sheet-like and have a thickness of 2-4 mm. The first and second connection portions 220b, 220c are perpendicular to the central portion 220a. The first connection portion 220b is parallel to the second connection portion 220c.

The central portion 220a has a multi-wall construction of the type as previously described. FIG. 17 shows a cross-sectional view of another inner glazing element 230 that may be used in a glazing according to the present invention.

The inner glazing element 230 is made of plastic and may be made by extrusion using a suitably configured die.

The inner glazing element 230 comprises a central portion 230a and first and second connection portions 230b, 230c integrally formed therewith.

The first connection portion 230b has a first connection element 232, a second connection element 234 and a third optional connection element 236.

The first connection element 232 and the second connection element 234 meet to form edge 238. The first connection portion 230b was formed such that the angle between the first connection element 232 and the second connection element 234 is less than 90°. By applying force to the underside of the second connection element 234, the second connection element 234 can be moved to be perpendicular to the first connection element 232 (shown in phantom as 240) by rotation about edge 238. If the force is removed, the second connection element 234 returns to the “at rest” configuration shown in FIG. 17a.

The second connection portion 230c has a first connection element 242, a second connection element 244 and a third optional connection element 246.

The first connection element 242 and the second connection element 244 meet to form edge 248. The second connection portion 230c was formed such that the angle between the first connection element 242 and the second connection element 244 is less than 90°. By applying force to the underside (the side facing the first connection portion 242) of the second connection element 244, the second connection element 244 can be moved to be perpendicular to the first element 242 (shown in phantom as 250).

The central portion 230a has a multi-wall construction of the type previously described.

FIG. 17b shows a cross-sectional representation of the inner glazing element 230 attached to two channel-section glazing elements 260, 270.

The second connection portion 230c is shown attached to the flange 260a of the first channel-section glazing element 260 and the flange 270a of the second channel section glazing element 270. The second connection element 244 is biased against the ends of the flanges 260a, 270a.

The central portion 230a is spaced apart from the web 260c of the first channel-section glazing element 260 to define a first air-space 265 therewith.

The first connection portion 230b is in an “at rest” position but can be used to connect two flanges of two further channel-section glazing elements when a glazing such as that shown in FIG. 14 is made. In such a glazing, there will be an additional air-space between the central portion 230a and one of the further channel-section glazing elements.

In the following FIGS. 18-22, with reference to FIGS. 1 and 2, the cross-section view shown is as viewed in the direction of the z-axis.

FIG. 18 shows a cross-sectional view of another inner glazing element 300.

The inner glazing element 300 comprises a central portion 300a and along a first side thereof a first connection portion 300b, and along a second opposite side thereof, a second connection portion 300c. The first and second connection portions 300b, 300c are integrally formed with the central portion 300a.

In this example the central portion 300a has a multi-wall construction. The first and second connection portions 300b, 300c are also multi-wall construction.

FIG. 19 shows a cross-sectional view of another inner glazing element 310.

The inner glazing element 310 comprises a central portion 310a and along a first side thereof a first connection portion 310b, and along a second side thereof, a second connection portion 310c. The first and second connection portions 310b, 310c are integrally formed with the central portion 310a.

In this example the central portion 310a has a multi-wall construction. The first and second connection portions 310b, 310c are also multi-wall construction but have less cavities than the corresponding first and second connection portions 300b, 300c of the inner glazing element 300 shown in FIG. 18.

FIG. 20 shows a cross-sectional view of another inner glazing element 320.

The inner glazing element 320 comprises a central portion 320a and along a first side thereof a first connection portion 320b, and along a second side thereof, a second connection portion 320c. The first and second connection portions 320b, 320c are integrally formed with the central portion 320a.

The first connection portion 320b has a first connection element 322 being a multi-wall construction. The first connection element 322 is perpendicular to the central portion 320a.

The first connection portion 320b also has a second connection element 324. The second connection element 324 is also a multi-wall construction and is arranged to be perpendicular to the first connection element 322 and parallel to the central portion 320a.

The second connection portion 320c has a first connection element 326 being a multi-wall construction. The first connection element 326 is perpendicular to the central portion 320a.

The second connection portion 320c also has a second connection element 328. The second connection element 328 is also a multi-wall construction and is arranged to be perpendicular to the first connection element 326 and parallel to the central portion 320a.

The first connection element 322 is parallel to the first connection element 326. The second connection element 324 is parallel to the second connection element 328.

FIG. 21 shows a cross-sectional view of another inner glazing element 330. The inner glazing element 330 is essentially the same as the inner glazing element 320 with the exception of the second connection elements 324, 328.

The second connection element 324 has integrally formed therewith a third connection element 325. The third connection element 325 is also a multi-wall construction but has fewer cavities than the second connection element 324. The third connection element 325 is perpendicular to the second connection element 324 and parallel to the first connection element 322.

The second connection element 328 has integrally formed therewith a third connection element 329. The third connection element 329 is also a multi-wall construction but has fewer cavities than the second connection element 328. The third connection element 329 is perpendicular to the second connection element 328 and parallel to the first connection portion 326.

FIG. 22 shows a cross-sectional view of another inner glazing element 340. The inner glazing element 340 is essentially the same as the inner glazing element 320 with the exception that there is no second connection element 324 (and consequently no third connection element 325).

In an alternative to the embodiment shown in FIG. 22, the third connection element 329 may not be present.

The inner glazing elements shown in FIGS. 18-22 may be made by extrusion of a suitable plastic material through a suitably configured die.

All inner glazing elements shown in FIGS. 18-22 are made of a suitable plastic material such as polycarbonate.

Suitably the plastic material is optically transparent or translucent. The plastic may be tinted to provide a transmitted colour when viewed therethrough.

The present invention provides a glazing that using an inner glazing element made of plastic to improve the thermal performance. Using a suitably configured inner glazing element having a multi-wall configuration also helps further improve thermal performance.

By having an inner glazing element with at least one integrally formed connection portion, compared to using separate clips, the present invention allows glazings to be produced more quickly. Also, there is no need for separate components so that inventory costs and storage requirement can also be reduced.

Accordingly, glazings comprising first and second channel-section glazing elements are described. The first and second channel-section glazing elements are arranged to define a cavity in which an inner glazing element made of plastic is located. The inner glazing element comprises a central portion and first and second edge portions running along opposite sides of the central portion. The first edge portion of the inner glazing element comprises a first connection portion in mechanical communication with a first flange of the first channel-section glazing element. The first connection portion is integrally formed with the central portion of the inner glazing element. In preferred embodiments the second edge portion of the inner glazing also comprises a second connection portion that is preferably integrally formed with the central portion of the inner glazing element.

1.-27. (canceled)

28. A glazing comprising a first channel-section glazing element and a second channel-section glazing element, the first and second channel-section glazing elements each comprising a web and a first flange, the first flange running along a first lateral edge of the respective web, the first and second channel-section glazing elements being arranged such that the first flange of the first channel-section glazing element faces the second channel-section glazing element and the first flange of the second channel-section glazing element faces the first channel-section glazing element, wherein an inner glazing element made of plastic is located between the first and second channel-section glazing elements, the inner glazing element comprising a central portion, a first edge portion running along a first side of the central portion and a second edge portion running along a second side of the central portion, the first side of the central portion being opposite the second side of the central portion, wherein the first edge portion of the inner glazing element is adjacent the first flange of the first channel-section glazing element, characterised in that the first edge portion of the inner glazing element comprises a first connection portion in mechanical communication with the first flange of the first channel-section glazing element, the first connection portion being integrally formed with the central portion.

29. The glazing according to claim 28, wherein the glazing is arranged such that there is a first space between the central portion of the inner glazing element and the web of the first channel-section glazing element and a second space between the central portion of the inner glazing element and the web of the second channel-section glazing element.

30. The glazing according to claim 28, wherein the first connection portion of the inner glazing element is attached to the first flange of first channel-section glazing element.

31. The glazing according to claim 28, wherein the first flange of first channel-section glazing element has a first gasket on at least a portion thereof, and the first connection portion of the inner glazing element is attached to the first flange of first channel-section glazing element using the first gasket.

32. The glazing according to claim 28, wherein the central portion of the inner glazing element has a multi-wall construction comprising a first wall facing the web of the first channel-section glazing element and a second wall facing the web of the second channel-section glazing element, there being a plurality of air-spaces between the first and second walls of the central portion of the inner glazing element.

33. The glazing according to claim 28, wherein the first connection portion comprises a first element biased against the first flange of the first channel-section element and/or wherein the first connection portion is adhesively attached to the first flange of the first channel-section glazing element.

34. A glazing according to claim 28, wherein the web of the first channel-section glazing element has a second flange running along a second lateral edge thereof, the second lateral edge of the web of the first channel-section glazing element being opposite the first lateral edge of the web of the first channel-section glazing element and/or wherein the web of the second channel-section glazing element has a second flange running along a second lateral edge thereof, the second lateral edge of the web of the second channel-section glazing element being opposite the first lateral edge of the web of the second channel-section glazing element.

35. The glazing according to claim 28, wherein the first flange of the first and second channel-section glazing elements each has a respective first end opposite the respective web thereof, the glazing being arranged such that the first end of the first flange of the first channel-section glazing element faces the first end of the first flange of the second channel-section glazing element.

36. The glazing according to claim 28, wherein the web of the first channel-section glazing element has a second flange running along a second lateral edge thereof, the second lateral edge of the web of the first channel-section glazing element being opposite the first lateral edge of the web of the first channel-section glazing element; and wherein the web of the second channel-section glazing element has a second flange running along a second lateral edge thereof, the second lateral edge of the web of the second channel-section glazing element being opposite the first lateral edge of the web of the second channel-section glazing element; and wherein an end of the first flange of the first channel-section glazing element faces an end of the first flange of the second channel-section glazing element and an end of the second flange of the first channel-section glazing element faces an end of the second flange of the second channel-section glazing element.

37. The glazing according to claim 28, wherein the second edge portion of the inner glazing element comprises a second connection portion.

38. The glazing according to claim 37, wherein the second connection portion is integrally formed with the central portion.

39. The glazing according to claim 37, wherein the second connection portion of the inner glazing element is in mechanical communication with the first flange of the second-channel section glazing element, or when present, the second flange of the second channel-section glazing element.

40. The glazing according to claim 37, wherein the first flange of second channel-section glazing element has a first gasket on at least a portion thereof, and the second connection portion of the inner glazing element is attached to the first flange of second channel-section glazing element using the first gasket, or when present, the second flange of second channel-section glazing element has a first gasket on at least a portion thereof, and the second connection portion of the inner glazing element is attached to the second flange of second channel-section glazing element using the first gasket.

41. The glazing according to claim 37, wherein the second connection portion comprises a first element biased against the first flange of the second channel channel-section element, or when present, the second flange of the second channel-section glazing element; or wherein the second connection portion is adhesively attached to the first flange of the second channel-section glazing element, or when present, the second flange of the second channel-section glazing element.

42. The glazing according to claim 37 wherein the second connection portion has a multi-wall construction comprising at least a first and a second wall with at least one air space therebetween.

43. The glazing according to claim 28, wherein the first connection portion has a multi-wall construction comprising at least a first and a second wall with at least one air space therebetween.

44. The glazing according to claim 36, wherein the first connection portion of the inner glazing element is in mechanical communication with the first flanges of the first and second channel section glazing elements.

45. The glazing according to claim 44, wherein the second edge portion of the inner glazing element comprises a second connection portion and wherein the second connection portion of the inner glazing element is in mechanical communication with the second flanges of the first and second channel-section glazing elements, preferably wherein the second connection portion of the inner glazing element is attached to the second flanges of the first and second channel section glazing elements.

46. The glazing according to claim 28, further comprising a third channel-section glazing element comprising a web and a first flange running along a first lateral edge thereof, the glazing being arranged such that the first flange of the first channel-section glazing element faces the web of the third channel-section glazing element; the first flange of the second and third channel-section glazing elements faces the web of the first channel-section glazing element, and wherein the first flange of the third channel-section glazing element is between the first flange of the first channel-section glazing element and the first flange of the second channel-section glazing element.

47. The glazing according to claim 46, wherein the first connection portion is in mechanical communication with the first flange of the second channel-section glazing element and/or the first flange of the third channel-section glazing element.
